(19) United States
(12) Patent Application Publication
(10) Pub. No.: US 2015/0336254 A1
(43) Pub. Date: Nov. 26, 2015

(54) Automatic Hammer

(71) Applicants: Jeremy Charles Stetson, Lake Arrowhead, CA (US); Joshua Phillip May, Twin Peaks, CA (US)

(72) Inventors: Jeremy Charles Stetson, Lake Arrowhead, CA (US); Joshua Phillip May, Twin Peaks, CA (US)

(21) Appl. No.: 14/287,059

(22) Filed: May 26, 2014

(51) Int. Cl. B25D 1/00; B25D 1/14; B25C 5/16; B25C 1/02

(52) U.S. Cl. CPC B25D 1/005; B25C 1/02; B25D 1/14; B25C 5/1665; B25C 5/1686

(57) ABSTRACT

A framing hammer including an automatic feeding magazine supported within the hammerhead by guide rails with a self-loading magazine. Through the center of the upper portion of the hammer handle lies the self-loading reciprocating magazine. The top end of the magazine actuates due to the force of the impact of the tool through its natural operation. The magazine is inclined at 21° relative to the handle and is spaced in the center of the handle from the rear of the nail driving face. Structure is provided for individually driving a nail from a magazine contained row of commercially available 21° collated nails toward the rearward facing end of the hammerhead. Upon impact the tool dispenses and sets a nail up to a 1½″ into the work surface, upon disengagement the tool reciprocates to resets to its resting position whereupon the tool is ready to repeat the action.

### BACKGROUND OF THE INVENTION

The Automatic Hammer is a combination of the common use hammer and pneumatic nail gun. A nail gun, nailgun, or nailer is a type of tool used to drive nails into wood or some other kind of material. The first nail gun used air pressure and was introduced to the market in 1950 to speed the construction of housing (Unknown, Nail Gun, n.d.).

A nail gun uses the most popular sort of nail-loading mechanism. The nails are connected together in a long strip. This nail strip loads into the gun's magazine, which feeds into the “barrel” of the gun. Springs in the base of the magazine push the nail strip into the barrel. When the hammer comes down, it separates the first nail from the strip, driving it out of the gun and into the wood. When the hammer is cocked back, the springs push the next nail into position (Harris, 2001).

Framing hammers, used for framing wooden houses, are heavy duty rip hammers with a straight claw. The hammer heads typically weigh from 20 to 32 ounces (567 to 907 grams) for steel heads, and 12 to 16 ounces (340 to 454 grams) for titanium heads. Heavy heads, longer handles, and milled faces allow for driving large nails quickly into dimensional lumber.

Framing hammers have increasingly been replaced by nail guns for the majority of nails driven on a wood framed house. A hammer is a tool meant to deliver an impact to an object. The most common uses are for driving nails, fitting parts, forging metal and breaking up objects. Hammers are often designed for a specific purpose, and vary widely in their shape and structure. The usual features are a handle and a head, with most of the weight in the head. The basic design is hand-operated, but there are also many mechanically operated models for heavier uses, such as steam hammers.

The hammer may be the oldest tool for which definite evidence exists. Stone hammers are known to be dated to 2,600,000 BCE. The hammer is a basic tool of many professions. By analogy, the name hammer has also been used for devices that are designed to deliver blows. The essential part of a hammer is the head, a compact solid mass that is able to deliver the blow to the intended target without itself deforming.

In recent years the handles have been made of durable plastic or rubber. The hammer varies at the top; some are larger than others giving a larger surface area to hit different sized nails and such (Unknown, n.d.).

### WORKS CITED

Harris, T. (2001, Sep. 3). How Nail Guns Work. Retrieved from How Stuff Works?: http://home.howstuffworks.com/nail-gun1.htm
Unknown. (n.d.). Hammer. Retrieved Feb. 23, 2014, from Wikipedia: http://en.wikipedia.org/wiki/Hammer
Unknown. (n.d.). Nail Gun. Retrieved Feb. 23, 2014, from Wikipedia: http://en.wikipedia.org/wiki/Nail_gun

### BRIEF DESCRIPTION OF THE SEVERAL VIEWS OF THE DRAWING

1A—Hammer Body
2A—Neck
3A—Hammerhead
4A—Divided Hammer Handle
5A—Roll Pin
6A—Guide Rail Channel
7A—Guide Rail Channel Spring
8A—Hammer Handle
9A—Hammer Hanger
1B—Nail Magazine
2B—Guide Rail
3B—Nail Guide Rail
4B—Top Collated Nail Guide
5B—Stop Tab
6B—Rubber Magazine Head
1C—Spring Follower
2C—Stop Lever Mechanism
3C—Stop Lever
4C—Stop Lever Roll Pin
5C—Stopper Spring
6C—Magazine Spring
1D—Inertia Device Housing
2D—Inertia Device Plunger
3D—Inertia Device Spring
4D—Inertia Device Notch
1E—Nail Driver
2E—Nail Driver Spring Stop
3E—Nail Driver Spring

### BRIEF SUMMARY OF THE INVENTION

This is the next generation of the hammer. This is an auto-feed system of installing nails or modern fasteners used in any common facet in general construction ranging from but not limited to from rough carpentry, finish carpentry, and all other practical uses where a fastener is utilized. The system is designed to have an interchangeable magazine and nail driver to accommodate any nail size lending itself to the diversity of this product. This system will eliminate the need to manually hold a fastener during the act of installing said fastener as the entire operation can be done with one hand as opposed to modern techniques which includes the use of employing two hands; one hand to hold the fastener and the other hand to operate the hammer. This entire single operation is accomplished through the act of manually swinging the hammer system with enough force to actuate the magazines' lateral movement upon impact with the work surface, thereby driving the fastener into the intended position. Upon impact and installation of said fastener into the work surface, the subsequent nail from contained clip of nails will lift to position from a spring pressured spring follower resulting in a fully prepared ready for actuated impact of the Automatic Hammer.

Upon installation of fasteners into the work surface, the advantage and intended use of the device is rotated 180° within the workhand. Once the hammer is rotated, the Automatic Hammer system is used to complete the installation of fastener through manual swinging and impact of the hammer head to fastener. The resulting installation of fastener does not release an additional nail on the opposite side of the hammer, due to the inertia device system. The inertia device system restrains all lateral movement of the nail magazine. The prevention of the nail magazine from lateral movement upon impact is due to the inertia device plunger extending into the inertia device notch contained within the hammer body. Once impact is complete, the inertia device plunger is reset to its natural position by the force of the inertia device spring into the inertia device housing.

This Automatic Hammer solves the inherent problem of utilizing two hands as opposed to the one-handed operation with this device. Secondly, the safety implications of one handed use resolves the issue of impact to user; from holding fastener with one hand and possible injury with hammer from other hand.

The object of this invention is to more efficiently install a fastener into a work surface with minimal effort as compared to currently used techniques due to the limited technologies of the basic hammer.

### DETAILED DESCRIPTION OF THE INVENTION

### Process of Making Automatic Hammer

### Forming the Automatic Hammer Body (1A), Inertia Device Plunger Stop Lever (2D), Nail Driver (1E), and Guide Rails (2B)

The head is made by a process called hot forging. A length of steel bar is heated to about 2,200-2,350° F. (1,200-1,300° C.). This may be done with open flame torches or by passing the bar through a high-power electrical induction coil.
The hot bar may then be cut into shorter lengths, called blanks, or it may be fed continuously into a hot forge. The bar or blanks are positioned between two formed cavities, called dies, within the forge. One die is held in a fixed position, and the other is attached to a movable ram. The ram forces the two dies together under great pressure, squeezing the hot steel into the shape of the two cavities. This process is repeated several times using different shaped dies to gradually form the hammer head. The forging process aligns the internal grain structure of the steel and provides a much stronger and more durable piece.
During this process, some of the hot steel squeezes out around the edges of the die cavities to form flash, which must be removed. As a final step the head is placed between two trimming dies, which are forced together to cut off any protruding flash. The head is then cooled, and any rough spots are ground smooth.
In order to prevent chipping and cracking of the hammer head in service, the face, poll, and claws are heat treated to harden them.
Hammer heads are made of high carbon, heat-treated steel for strength and durability. The heat treatment helps prevent chipping or cracking caused by repeated blows against other metal objects (Cavette, n.d.).

### Forming the Automatic Hammer Nail Magazine (1B), Spring Follower (1C), and Top Collated Nail Guide (4B)

The Nail Magazine will be manufactured though the process of bending and welding to the specifications and tolerances which are to be determined during the initial prototype phase. The process of bending which is typically performed on a machine called a press brake, which can be manually or automatically operated. For this reason, the bending process is sometimes referred to as press brake forming. A press brake contains an upper tool called the punch and a lower tool called the die, between which the sheet metal is located. The sheet is carefully positioned over the die and held in place by the back gauge while the punch lowers and forces the sheet to bend. In an automatic machine, the punch is forced into the sheet under the power of a hydraulic ram. The bend angle achieved is determined by the depth to which the punch forces the sheet into the die. This depth is precisely controlled to achieve the desired bend (Sheet Metal Forming, n.d.).

### Forming the Automatic Hammer Handle (8A)

The handle will be made of a composite or fiberglass material at specifications to be determined during the research and development phase. The handle will be approximately nine inches long with an oblong shape to be best suited for gripping.

### Common Outsourced Parts

Certain parts will be outsourced once they have been determined in size and strength. Such as springs (7A, 5C, 6C, 3D, and 3E), roll pins (5A and 4C), and the rubber magazine head (6B).

### DESCRIPTION OF EACH DRAWING

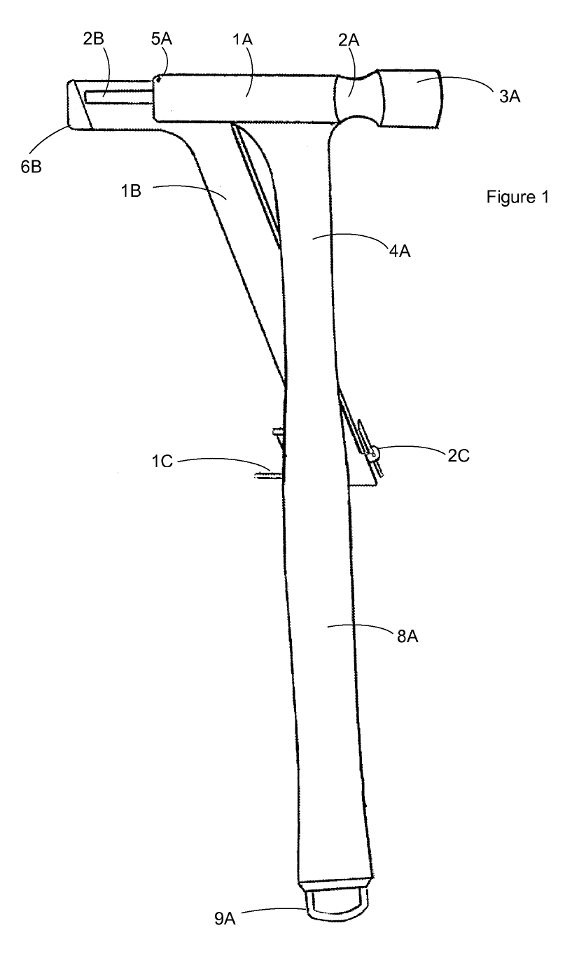

FIG. 1—Side view of Automatic Hammer

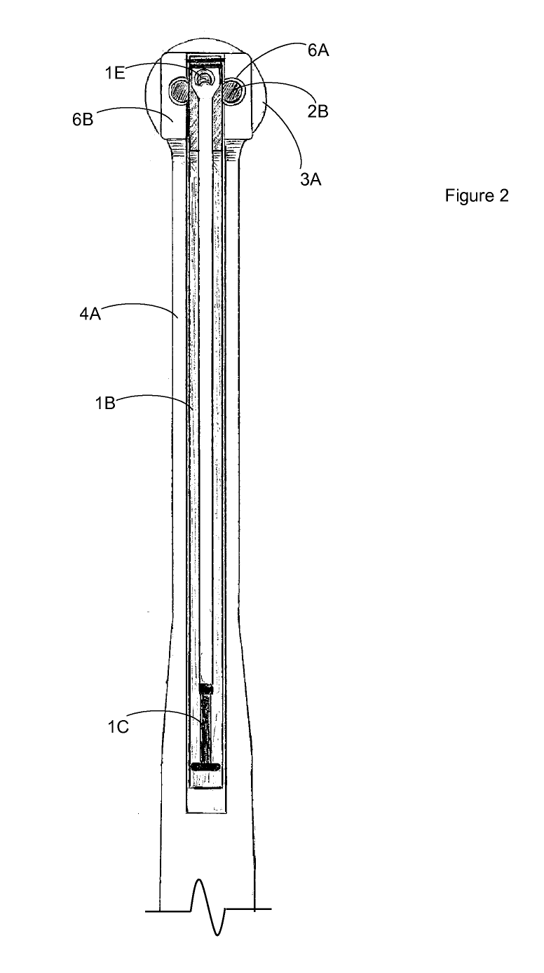

FIG. 2—Front view of Automatic Hammer

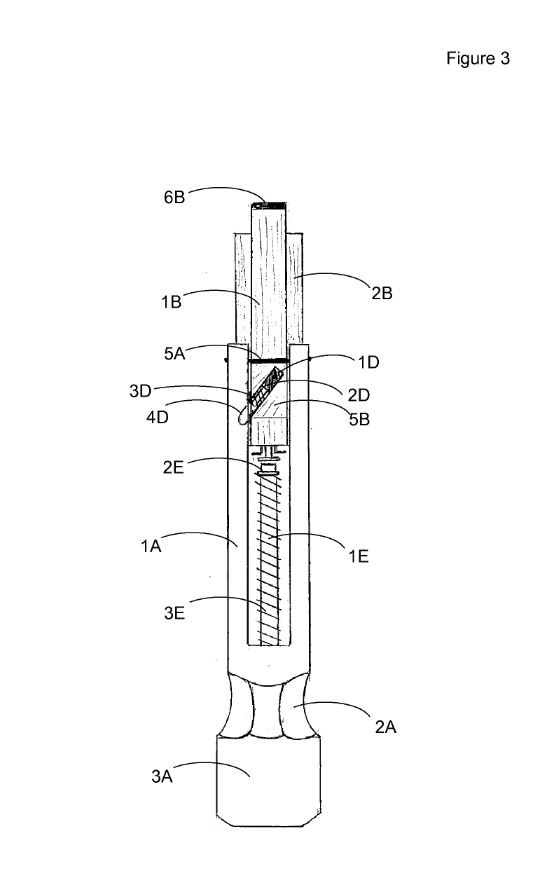

FIG. 3—Top view of Automatic Hammer

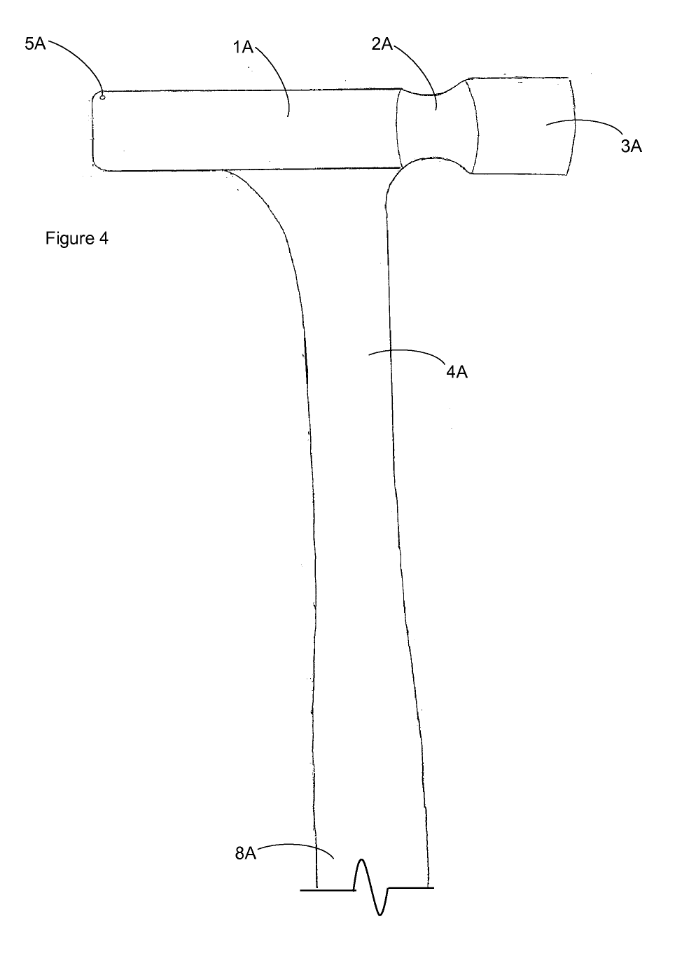

FIG. 4—Side view of Automatic Hammer Body

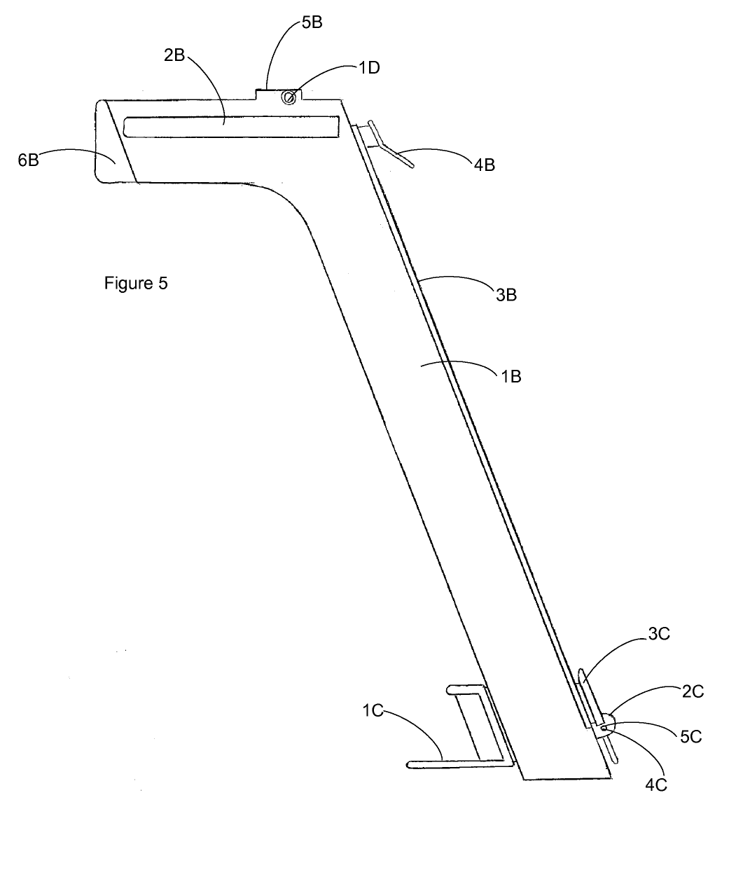

FIG. 5—Side view of Automatic Hammer Magazine

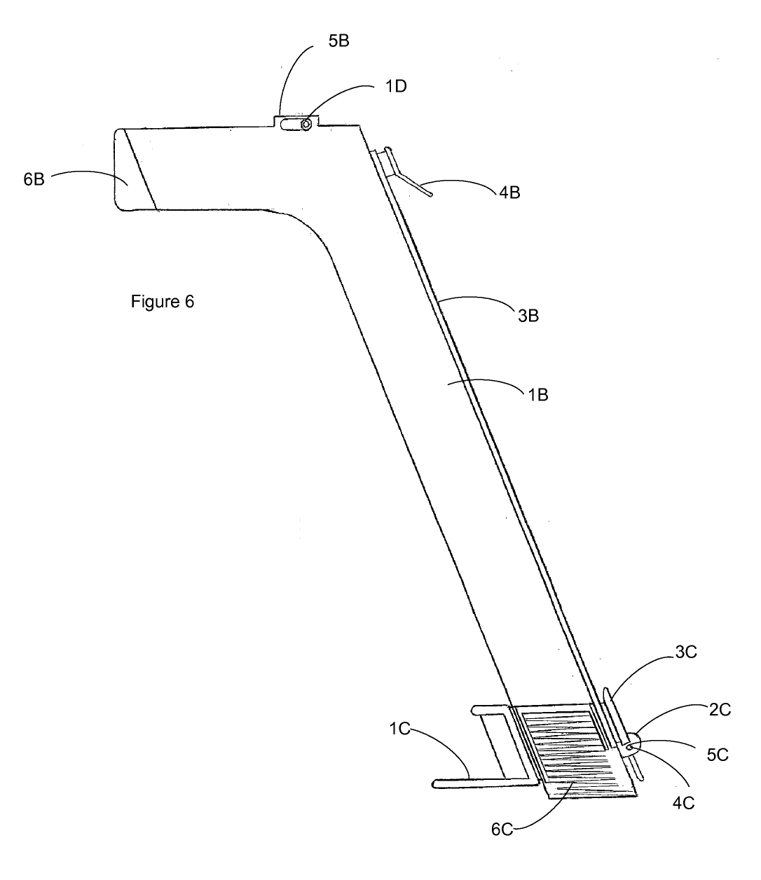

FIG. 6—Cross section Automatic Hammer Magazine

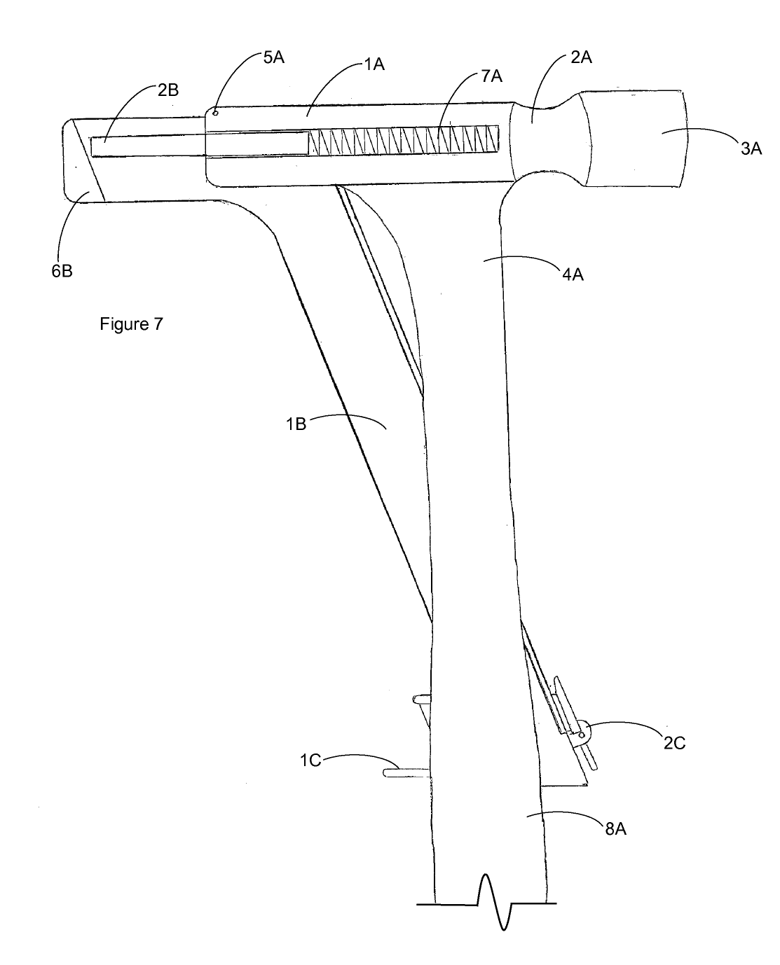

FIG. 7—Side view cross section Automatic Hammer

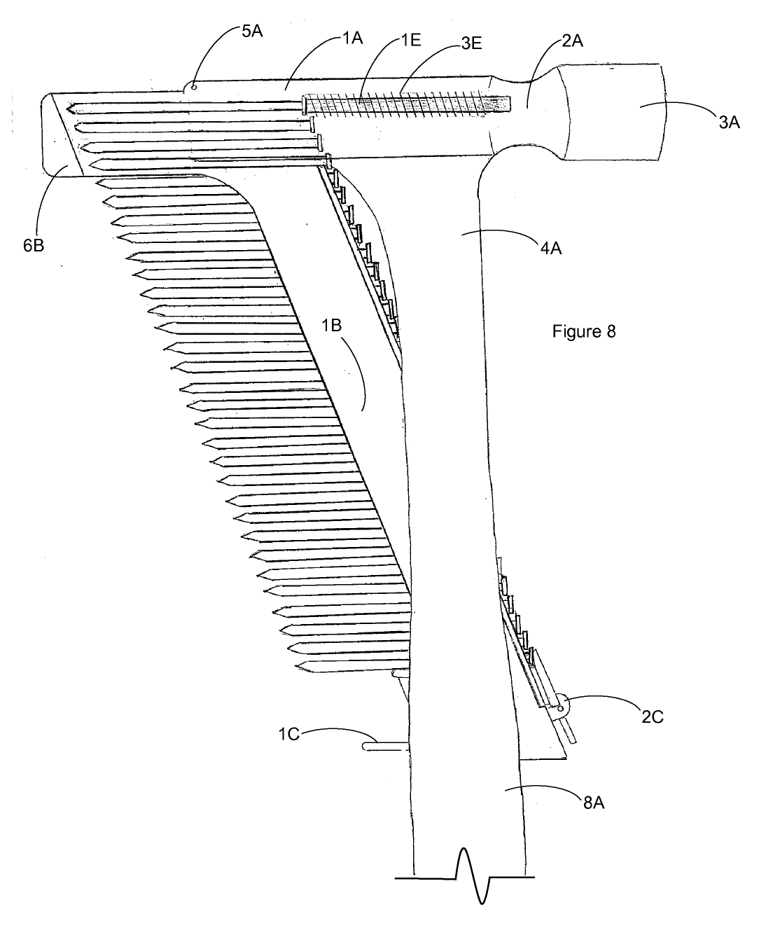

FIG. 8—Side view with cut in hammer body and upper magazine only

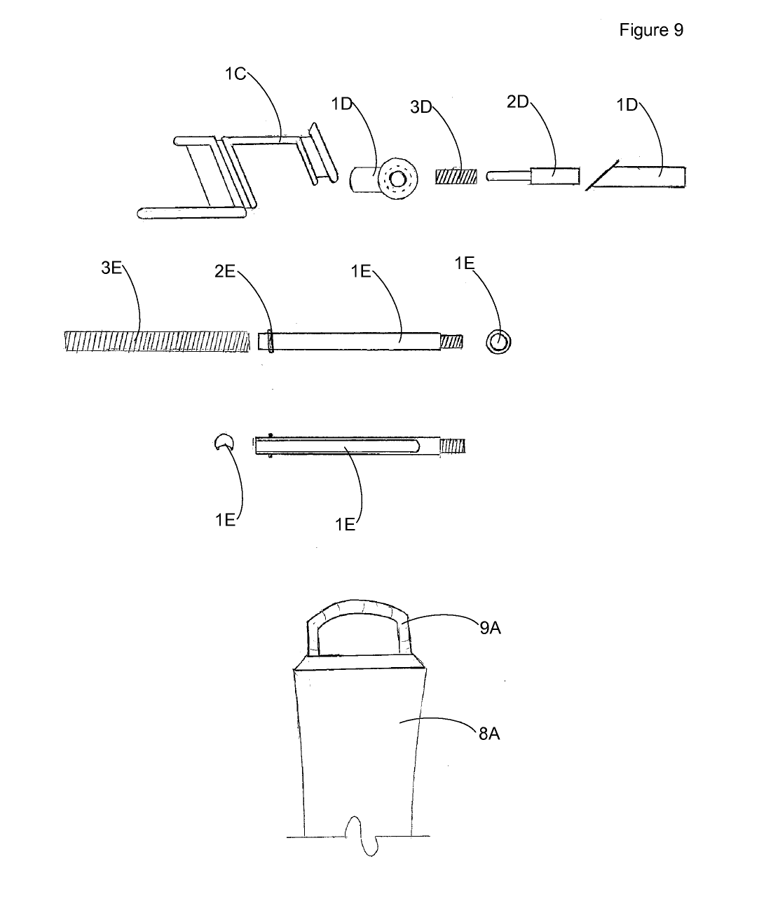

FIG. 9—Individual views of small parts of Automatic Hammer

### INDIVIDUAL PARTS LIST AND INTERACTION

FIG. 1 is the side view of the Automatic Hammer with integrated magazine composed of hammer body (1A), divided hammer handle (4A), and hammer handle (8A), and is broken down in more detail in FIG. 7 showing the following components roll pin (5A), neck (2A), hammer head (3A), guide rail channel (6A), and guide rail spring (7A).

FIG. 3 is a top view of the Automatic Hammer with integrated magazine more specifically composed of the inertia device system including the following parts: inertia device housing (1D), inertia device plunger (2D), inertia device spring (3D), and inertia device notch (4D).

The illustrated integrated magazine in FIG. 1 is composed of parts of the nail magazine (1B) broken down and in more detail in FIG. 6 showing the following components guide rail (2B), stop tab (5B), top collated nail guide (4B), rubber magazine head (6B), nail magazine (1B), nail guide rail (3B), stop lever (3C), stopper spring (5C), stop lever mechanism (2C), stop lever roll pin (4C), magazine spring (6C), and spring follower (1C).

FIG. 9 is the small parts individually designed. These parts consist of a spring follower (1C), nail driver spring (3E), nail driver spring stop (2E), nail driver (1E), hammer handle (8A), and hammer hanger (9A).

Through the set of a nail use of the Automatic Hammer, this entire single operation is accomplished through the act of manually swinging the component with enough force to actuate the nail magazines' (1B) lateral movement upon impact with the work surface, there by driving the fastener into the intended position. This entire sequence starts with the impact of the rubber magazine head (6B), which is connected to the face of the nail magazine (1B), with the intended work surface through the manual use of this device. Upon impact with said work surface the nail magazine (1B) moves laterally through the divided hammer handle (4A) while being supported by the guide rails (2B) within the guide rail channels (6A) and guided through the divided hammer handle (4A) to prevent side to side movement.

While this is occurring during impact with the device to the work surface, the guide rail channel spring (7A) contained within the guide rail channel (6A) is compressed. As can be seen in FIG. 8, the top collated nail held within the nail magazine (1B) remains in a fixed position against the nail driver (1E) as the lateral movement of the nail magazine (1B) naturally compresses the nail driver spring (3E). The action leaves the nail in the work surface up to a maximum 1½″. The collation of the nails contained with the nail magazine (1B) are striped off of referenced set nail, due to the rearward lateral movement of the nail magazine (1B).

After impact and removal of the Automatic Hammer from the surface, the springs move into action. The guide rail channel springs (7A) and nail driver spring (3E), which is retained by the nail driver spring stop (2E), decompress and subsequently force the nail magazine (1B) to its original resting position. The nail magazine (1B) is prevented from exiting the hammer body (1A) through the retention of a roll pin (5A) and stop tab (5B). Upon the nail magazine (1B) reaching its natural resting position, the collated nails contained in the nail magazine (1B) are forced upward along the nail guide rail (3B) by the contained spring follower (1C) which is forced by the decompression of the magazine spring (6C) which allows the top most collated nail to be guided into position by the top collated nail guide (4B) contained within the nail magazine (1B) to a loaded position against the nail driver (1E).

Once all intended nails have been set into the work surface detailed in the sequence of operations above, the Automatic Hammer is rotated 180° in the workhand. The user will then proceed to drive set nails completely into the work surface through impact of the hammer head (3A) supported by the neck (2A). The prevention of the nail magazine (1B) from lateral movement upon impact is due to the inertia device plunger (2D) extending into the inertia device notch (4D) contained within the hammer body (1A). Once impact is complete, the inertia device plunger (2D) is reset to its natural position by the force of inertia device spring (3D) into the inertia device housing (1D).

Once the Automatic Hammer is out of nails, the user must insert a fresh set of collated nails. This is done by holding the Automatic Hammer within the workhand and using off-hand to compress the magazine spring (6C) by manually pulling the spring follower (1C) until it is retained by the stop lever (3C). The stop lever (3C) is contained within the stop lever mechanism (2C) and retained in place by the stop lever roll pin (4C) which effectively compresses the stopper spring (5C). This allows for the manual insertion of a fresh set of collated nails within the nail guide rail (3B) track. Once complete the spring follower (1C) is released by disengaging the stop lever (3C).

The Automatic Hammer tool is designed to be hung from a carpenter's tool belt upside-down. This is done by a hook on the tool belt and a hammer hanger (9A) which is installed at the base of the hammer handle (8A).

### WORKS CITED

Cavette, C. (n.d.). Hammer. Retrieved May 10, 2014, from Made How: http://www.madehow.com/Volume-4/Hammer.html
Sheet Metal Forming. (n.d.). Retrieved May 10, 2014, from Custompart.net: http://www.custompartnet.com/wu/sheet-metal-forming

The invention claimed is:

1. A hammer body comprised of a portion divided at the rearward of the length of said body creating a separation, this separation comes together near the neck of the hammer body, which brings together a solid neck connected to a waffle faced hammer head at the frontward portion of the hammer body; extending from the hammer body towards the lower portion of the tool; the divided hammer handles continues the separation of said body, for clarity this creates a continuous separation starting from the hammer handle and ending at the neck of the hammer body.

2. The hammer body as in claim 1 wherein the guide rail channel is imbedded on each side of the rearward portion of the divided hammer body.

3. The hammer body as in claim 1 wherein the guide rail channel houses a guide rail channel spring.

4. The hammer body as in claim 1 wherein includes an inertia device notch in the divided body portion of said body.

5. The hammer body as in claim 1 wherein connects to a hammer handle, which will be made of fiberglass, composite, or metal wrapped by rubber as to yet be determined through research and development.

6. The hammer body as in claim 1 wherein a hammer hanger is placed at the base of the hammer handle in a circular design to hang on a tool belt.

7. A nail driver is the primary impact point between fastener and the Automatic Hammer for setting fasteners into work surfaces and is essentially a solid milled hardened rod with a groove milled into the lower portion of the rod to accommodate the next fastener contained within the collated nails; the nail driver is directly attached to the inner separation of the hammer body.

8. The nail driver as in claim 6 wherein a nail driver spring surrounds the nail driver, which forces the movement of the nail magazine to its natural resting position following the compression of the nail driver spring.

9. The nail driver as in claim 6 wherein a nail driver spring stop is attached at the head of the nail driver and contains the referenced nail driver spring between the nail driver spring stop and hammer body.

10. A nail magazine which holds the self-loading collated nails that will be used to install fasteners into the work surface is designed using sheet metal; the nail magazine is designed to attach to the hammer body and reciprocate through lateral movement due to impacts through the natural use of the tool within the separation of the hammer body and hammer body handle.

11. The nail magazine as in claim 9 wherein has a rubber magazine head attached to the upper impact point of the nail magazine.

12. The nail magazine as in claim 9 wherein a guide rail supports and directs the orientation of the nail magazine.

13. The nail magazine as in claim 9 wherein a stop tab is oriented on the upper portion of the nail magazine to create a stop for the nail magazine to the natural resting position against a roll pin installed within the hammer body.

14. The nail magazine as in claim 9 wherein the spring follower is housed within the nail magazine and is employed through compression of the magazine spring to feed the collated nails into the impact position with the nail driver; additionally, the spring follower is designed with a leading grip edge projecting out of the frontward face of the nail magazine and is used to reset said follower, which connects to the stop lever system on the rearward portion of the nail magazine.

15. The nail magazine as in claim 9 wherein a magazine spring is housed within the nail magazine to compress and decompress with the purpose of feeding the collated nails through the direct force of the magazine follower.

16. The nail magazine as in claim 9 wherein a top collated nail guide is oriented in the rear top portion of the nail magazine and is intended to guide the collated nails to the proper position for impact with nail driver.

17. The nail magazine as in claim 9 wherein a stop lever system is used to secure and catch the magazine follower for the intended use of loading collated nails and the stop lever mechanism is located on the bottom rear portion of the magazine containing a stop lever, stop lever spring, and stop lever roll pin.

18. The nail magazine as in claim 9 wherein an inertia device housing is located on the top portion of the nail magazine within the stop tab and contains an inertia device plunger and inertia device spring.

19. The nail magazine as in claim 9 wherein the inertia device plunger restrains all lateral movement of the nail magazine, due to the prevention of the nail magazine from lateral movement upon impact from the waffle faced hammer head is due to the inertia device plunger extending into the inertia device notch contained within the hammer body.

20. The nail magazine as in claim 9 wherein once impact is complete from the waffle faced hammer head, the inertia device plunger is reset to its natural position by the force of the inertia device spring into the inertia device housing.
